(19) United States
(12) Patent Application Publication
(10) Pub. No.: US 2021/0165608 A1
(43) Pub. Date: Jun. 3, 2021

(54) SYSTEM, DATA PROCESSING METHOD, AND PROGRAM

(71) Applicant: TONOI CO., LTD., Tokyo (JP)

(72) Inventors: Mitsuo KOIKAWA, Tokyo (JP); Takeyuki OGURA, Tokyo (JP)

(73) Assignee: TONOI CO., LTD., Tokyo (JP)

(21) Appl. No.: 17/045,359

(22) PCT Filed: Apr. 16, 2019
(86) PCT No.: PCT/JP2019/016260

§ 371 Date: Oct. 5, 2020

(30) Foreign Application Priority Data
May 7, 2018 (JP) 2018-089022
Sep. 23, 2018 (JP) 2018-178170

(51) Int. Cl. G06F 3/06; G06F 16/955

(52) U.S. Cl. CPC G06F 3/0659; G06F 16/955; G06F 3/0673; G06F 3/0604

(57) ABSTRACT

Provided are a system, a data processing method, and a program in which a method for designating a data position between memories is unified. A system 1 includes: a control part 10; and a storage part 20 which stores data on the basis of a data position. The system 1 uses, as a pointer for accessing the data, a uniform resource identifier (URI) in which a predetermined scheme is associated with a resource in a format defined for each scheme after a predetermined delimiter instead of the data position, the control part 10 controls and activates an application designated by the scheme associated with the URI and passes the resource of the URI to the application, and the application uses the URI as the data position on the basis of the resource and controls data specified by the URI and stored in the storage part 20.

### TECHNICAL FIELD

The present invention relates to a system, a data processing method, and a program. In particular, the present invention relates to a system, a data processing method, and a program in which a method for designating a data position is extended and unified.

### BACKGROUND ART

Conventionally, a memory device is known which includes a non-volatile memory, address conversion data which is stored in the non-volatile memory and in which a logical address designated as a write destination or a read destination is associated with a physical address indicating a position of the non-volatile memory by a hierarchical structure having a plurality of layers, a cache memory which can read and write at a higher speed than the non-volatile memory and stores a part of the address conversion data, an address conversion part which searches the part of the address conversion data to be stored in the cache memory in accordance with the hierarchical structure of the address conversion data, stores the part of the address conversion data in the cache memory, and converts the logical address into the physical address by referring to the cache memory, a write control part which writes write target data at the position indicated by the physical address acquired by the address conversion part when receiving a write command, and a read control part which reads read target data from the position indicated by the physical address acquired by the address conversion part when receiving a read command and in which a plurality of pieces of partial data having predetermined sizes included in the address conversion data belongs to a plurality of layers, first partial data belonging to a first layer of the plurality of layers includes a logical address and a plurality of pieces of reference destination information for referring to a plurality of pieces of second partial data belonging to a second layer lower than the first layer among the plurality of layers, and the least significant partial data in the hierarchical structure among the plurality of pieces of partial data includes a logical address and a physical address (for example, see Patent Literature 1). According to the memory device described in Patent Literature 1, the address conversion data can be efficiently managed.

### CITATION LIST

### Patent Literature

Patent Literature 1: JP 2018-041204 A

### SUMMARY OF INVENTION

### Technical Problem

In a computer, various memories (storage parts) such as a register, a cache, a dynamic random access memory (DRAM), a video memory, a solid state drive (SSD), and a hard disk drive (IDD) are used. These memories are connected to each other by various communication buses, and a predetermined address is assigned in each memory in a format different from each other. Further, in a case where various types of data processing are executed by a computer, the predetermined data used for the data processing is frequently transferred between the addresses of the individually divided memories. Therefore, when the data capacity used for the processing increases, the data transfer also increases.

In this case, for example, when the data transfer between DRAMs is compared with the data transfer between a DRAM and an SSD, the transfer between DRAMs is much faster than the transfer between a DRAM and an SSD. Thus, if the data exchanged between DRAMs is exchanged between a DRAM and an SSD, a data processing speed is significantly reduced due to an insufficient transfer rate.

Then, in the conventional technology such as the memory device described in Patent Literature 1, it is intended to efficiently manage the address conversion data. However, in a case where a predetermined data processing is executed, data cannot help being transferred from an SSD or HDD to a DRAM, and no consideration is given to the reduction in data processing speed caused by a difference in the rate of transfer between memories.

Therefore, an object of the present invention is to provide a system, a data processing method, and a program in which a method for designating a data position between memories is extended and unified.

### Solution to Problem

In order to achieve the above object, the present invention is a system including: a control part; and a storage part which stores data on the basis of a data position. The system uses, as a pointer for accessing the data, a uniform resource identifier (URI) in which a predetermined scheme is associated with a resource in a format defined for each scheme after a predetermined delimiter instead of the data position, the control part controls and activates an application designated by the scheme associated with the URI and passes the resource of the URI to the application, and the application uses the URI as the data position on the basis of the resource and controls data specified by the URI and stored in the storage part.

In the system, the storage part may include a plurality of storage parts to which the data positions of different formats are assigned, and the application may designate data stored in each of the plurality of storage parts on the basis of the URI.

In the system, the plurality of storage parts may include at least two storage parts selected from a group including a register, a cache, a DRAM, a video memory, an SSD, a HDD, a tape drive, an optical recording medium, a magneto-optical storage medium, and a magnetic recording medium.

In the system, the control part may also control and activate a plurality of applications on the basis of the scheme associated with the URI.

In the system, the data position is preferably a physical address.

In the system, the data position may be specified including at least an IO controller number.

In the system, the storage part may store image data including a URI in which a predetermined scheme is associated with a resource in a format defined for each scheme after a predetermined delimiter, and the application may be an image processing application which performs predetermined processing on the image data.

In order to achieve the above object, the present invention is a data processing method in a system which includes a control part and a storage part which stores data on the basis of a data position. The method includes: a step of using, by the system, as a pointer for accessing the data, a uniform resource identifier (URI) in which a predetermined scheme is associated with a resource in a format defined for each scheme after a predetermined delimiter instead of the data position; a step of controlling and activating, by the control part, an application designated by the scheme associated with the URI and passing the resource of the URI to the application; and a step of using, by the application, the URI as the data position on the basis of the resource and controlling data specified by the URI and stored in the storage part.

In order to achieve the above object, the present invention is a program for a system which includes a control part and a storage part which stores data on the basis of a data position. The program for causing a computer to realize: a function of using, as a pointer for accessing the data, a uniform resource identifier (URI) in which a predetermined scheme is associated with a resource in a format defined for each scheme after a predetermined delimiter instead of the data position; a function of controlling and activating an application designated by the scheme associated with the URI and passing the resource of the URI to the application; and a function of the application using the URI as the data position on the basis of the resource and controlling data specified by the URI and stored in the storage part.

In order to achieve the above object, the present invention is a program for a system which includes a control part and a storage part which stores data on the basis of a data position. The program for causing a computer to realize: a function. of using, as a pointer for accessing the data, a uniform resource identifier (URI) in which a predetermined scheme is associated with a resource in a format defined for each scheme after a predetermined delimiter instead of the data position; a function of controlling and activating an application designated by the scheme associated with the URI and passing the resource of the URI to the application; and a function of the application using the URI as the data position on the basis of the resource and processing data specified by the URI and stored in the storage part.

### Advantageous Effects of invention

According to the system, the data processing method, and the program of the present invention, it is possible to provide the system, the data processing method, and the program in which the method for designating the data position between the memories is extended and unified.

### BRIEF DESCRIPTION OF DRAWINGS

FIG. 1 is a functional configuration block diagram of a system according to this embodiment.

FIG. 2 is a diagram illustrating a memory hierarchy.

FIG. 3 is a flowchart of processing in an application example of the system according to this embodiment.

FIG. 4 is a flowchart of processing in an application example of the system according to this embodiment.

### DESCRIPTION OF EMBODIMENTS

### Embodiment

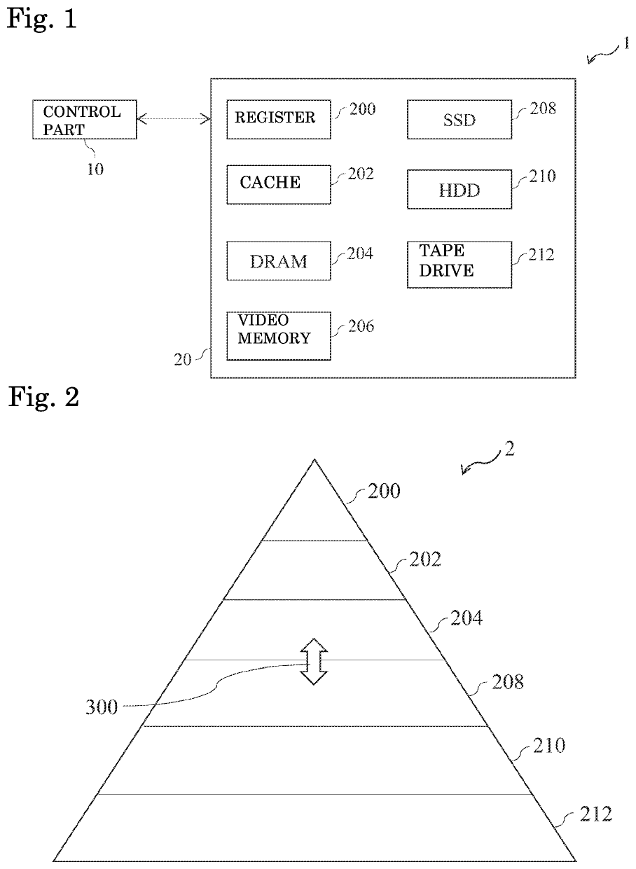

FIG. 1 illustrates an example of a functional configuration of a system according to an embodiment of the present invention. Further, FIG. 2 is a diagram illustrating a memory hierarchy.

(Outline of System 1)

In a conventional computer program, a plurality of routines pass physical addresses called pointers, and data on a dynamic random access memory (DRAM) is used or processed in common among a plurality of routines. Therefore, it is necessary to transfer data in the lower layer of the memory hierarchy such as a solid state drive (SSD) to the DRAM once. Herein, when the amount of data handled between the DRAM and the SSD increases, the conventional method cannot secure a sufficient transfer rate, and the data transfer to the DRAM becomes a bottleneck of data processing.

When the description is given with reference to a memory hierarchy 2, in the memory hierarchy 2, a cache 202 is positioned below a register 200, a DRAM 204 is positioned below the cache 202, an SSD 208 is positioned below the DRAM 204, a hard disk drive (HDD) 210 is positioned below the SSD 208, and a tape drive 212 is positioned below the HDD 210. Then, a data transfer 300 between the DRAM 204 and the SSD 208 is a bottleneck.

In this regard, in a system 1 according to this embodiment, from the viewpoint of eliminating the bottleneck, management by a physical address is changed to management by a uniform resource identifier (URI). That is, the system 1 according to this embodiment includes a control part 10 and a storage part 20 which stores data at an address indicated by a data position (for example, physical address, addresses of various storage parts, and an IO controller number). In the system 1, as a pointer for accessing data, a URI is used in which a predetermined scheme is associated with a resource in a format defined for each scheme after a predetermined delimiter (for example, “:” (colon)). That is, in the system 1 according to this embodiment, the position of data that can be processed by the control part 10 is “extended” when a pointer indicating a data position inside a computer is changed or substituted from a physical address to a URI. In other words, the system 1 uses the URI instead of the data position. Incidentally, the pointer is a tag used when the computer program passes the position of data to be processed between routines.

(Control Part 10)

The control part 10 controls various data processing and the like in the system 1 The control part 10 operates the storage part 20 to execute the transferring, processing, or the like of the data stored in the storage part 20 and the control of a predetermined application. For example, the control part 10 is configured to include a logic circuit of a central processing unit (CPU).

The control part 10 controls and activates the predetermined application designated by the scheme associated with the URI. Then, the control part 10 passes the resource of the URI to the application. Subsequently, the application processes the data designated by the URI and stored in the storage part 20 by using the URI as the data position on the basis of the resource. Incidentally, the control part 10 can also control and activate a plurality of applications on the basis of the scheme associated with the URI. Further, the application may further have a function (transfer function) of transferring predetermined data as a part of the processing, or the application may have only the transfer function. In this case, the application transfers the predetermined data to a predetermined storage part.

Incidentally, the URI is an identifier which indicates a resource in a predetermined certain format. In the URI according to this embodiment, the resource for enabling access by the control part 10 or the application can be indicated in consideration of a case where target data does not exist in the system 1. Further, in order that the control part 10 and the application can be allowed to access the resource indicated by the URI, it is necessary to convert the URI to a physical address in the actual storage part. Thus, the same physical address may be indicated by a plurality of URIs. Incidentally, the conversion or substitution of a URI into a physical address is executed by the application designated by the scheme associated with the URI.

For example, the URI is described in a format of “scheme://resource”, and the resource is described in a format defined for each scheme. Then, examples of the resource include “disk number, directory, file, seek in which target data exists”, “DRAM memory address in which target data exists”, and “correspondence, retry, call back when target data does not exist”, for example.

(Storage Part 20)

The storage part 20 is provided so as to be able to store predetermined data at a data position of predetermined format. As the storage part 20, various storage media can be used as long as the medium has a function of storing various data. Examples thereof include the register 200, the cache 202, the DRAM 204, a video memory 206, the SSD 208, the HDD 210, the tape drive 212, an optical recording medium such as a compact Disc (CD) and a digital versatile disc (DVD), a magneto-optical storage medium, and a magnetic recording medium. The data positions of different formats are assigned to these storage parts. Incidentally, in the memory hierarchy 2 illustrated in FIG. 2, for example, the control part 10 and the storage parts of the SSD 208 or lower are connected by an IO channel and controlled by an IO controller.

As an example, in the register 200, the cache 202, and the DRAM 204, the data position is designated using a physical address. Specifically, in the register 200, the data position is designated by the register name or number. In the cache 202, the data position is designated by the address counted along the permutation from the beginning. Also in the DRAM 204, the data position is designated by the address counted along the permutation from the beginning. However, in the DRAM 204, the designation of the data position is physically different from the cache 202.

The system 1 according to this embodiment includes at least two storage parts selected from these storage parts.

(Details of Processing of System 1)

The system 1 according to this embodiment is a system including a storage part 20 in which data is designated by a URI. Then, the control part 10 activates the application according to the scheme associated with the URI, and the resource of the URI is passed to the activated application. Then, the application converts the URI into a data position on the basis of the passed resource. Accordingly, the control part 10 can control the storage part 20 directly and uniformly regardless of the type of the storage part 20.

For example, as in the memory hierarchy 2 illustrated in FIG. 2, the conventional CPU directly controls the register 200, the cache 202, and the DRAM 204. Further, the conventional CPU cannot directly control the storage parts of the SSD 208 or lower. Since the transfer rate in the path for transferring data from the DRAM 204 to the SSD 208 is slower than the transfer rate in the storage part of the DRAM 204 or higher, the data transfer from the DRAM 204 to the SSD 208 becomes a bottleneck in terms of transfer rate no matter how fast the data transfer in the DRAM 204 or higher is. This is because in the conventional computer, a different format is used for each storage part, and the data position is designated by the physical address.

On the other hand, the system 1 according to this embodiment uses the URI as a pointer instead of the physical address. Therefore, the control part 10 can directly control the SSD 208 or the like which is a storage part in the lower layer than the DRAM 204. Specifically, in the control part. 10 according to this embodiment, in a case where the control part 10 accesses each storage part, the range accessible by the command of the control part 10 is the register 200, the cache 202, the DRAM 204, and the IO controller of the IO channel. Then, the control part 10 controls numerical values such as data positions held in the register 200, the cache 202, the DRAM 204, and the IO controller of the IO channel, the numerical values held in the IO controller are rewritten by the control part 10, and thus the storage parts such as the SSD 208, the HDD 210, and the tape drive 212 ahead of the IO controller are directly controlled by the control part 10.

As a result, for example, the DRAM 204 can be handled not as a data transfer destination/shared location but as a cache having a larger capacity than the cache 202, so that the data processing speed in the system 1 can be improved significantly.

More specifically, the control part 10 refers to the URI of predetermined data and activates the application designated by the scheme associated with the URI. The control part 10 passes the resource behind the delimiter of the URI to the application. On the basis of the resource, the application uses the URI as the data position instead of the physical address and accesses the data stored in the storage part designated by the URI. Accordingly, the control part 10 can centrally manage access to the SSD 208 and the like using the URI.

For example, if the application activated by the control part 10 is an SSD control routine, the SSD control routine generates the physical address of the SSD controller device or the physical address of the SSD memory space on the SSD controller on the basis of the resource. As a result, the control part 10 can control the SSD 208.

Incidentally, the application can also designate the data stored in each of the plurality of storage parts on the basis of the URI. That is, the application is controlled by the control part 10, and each of a plurality of pieces of data stored in the plurality of storage parts at the positions/addresses designated by physical addresses of different formats can be handled uniformly by using the URI. Accordingly, according to the system 1 of this embodiment, the designation of the data position among the plurality of storage parts can be extended by the URI and, as a result, can be handled uniformly.

In the system 1 according to this embodiment, the device driver included in the control part 10 controls the SSD 208, the HDD 210, and the like. In this embodiment, from the viewpoint of accelerating the processing of the system 1, the device driver can be changed into a form that can accept a plug-in. When the routine that handles the data designated by the pointer in the application is loaded as a plug-in of the device driver, the routine can operate inside the device driver, and the application can directly access a storage element such as the SSD 208 without passing through an operating system. Accordingly, the processing in the system 1 is accelerated.

### Effects of Embodiment

In the system 1 according to this embodiment, the URI is used as the pointer passed in the plurality of routines instead of the data position (physical address), and thus, the DRAM 204 can be used as a cache having a larger capacity than the cache 202, That is, in the system 1, it is not always necessary to transfer all of the data used for data processing to the DRAM 204, and only a part required for data processing of the data stored in the lower storage part of the memory hierarchy such as the SSD 208 can be accessed and processed (partial access). In a case where predetermined data is read from the lower storage part of the memory hierarchy such as the SSD 208, it is possible to perform processing (stream processing and the like) which incorporates the operations required for data processing.

Therefore, in the conventional management by physical address, the pointer is different for each storage part, However, according to the system 1 according to this embodiment, the same data can be pointed with the same pointer by using the URI, and thus the data in all storage parts can be managed uniformly. Thus, even in a case where the amount of data increases with respect to the transfer rate, data processing that is faster than the conventional address management can be realized by incorporating a technology of accelerating data processing such as partial access and stream processing into various applications. That is, according to the system 1 of this embodiment, it is possible to reduce wasteful data transfer, standardize the data transfer routine, and extend the data transfer routine.

In the conventional management by physical address, data is transferred onto the DRAM and aggregated, and data-intensive transfer/aggregation processing occurs on the system. As a result, the thermal efficiency of conventional systems is poor. On the other hand, in the system 1 according to this embodiment, the data is centrally managed by using the URI, so that the transfer/aggregation processing of the data transfer does not occur, and the thermal efficiency is improved.

The physical address differs from device to device, and thus in a case where data processing is distributed among a plurality of devices, it is necessary to transfer data individually to the DRAM of the device that executes data processing, so that wasteful power consumption and exhaust heat occur for data transfer between devices. On the other hand, in the system 1 according to this embodiment, the data is centrally managed by the URI, so that thus the data pointed to by the URI becomes the same among the devices, and wasteful data transfer does not occur in a case where distributed processing is performed among the devices. Thus, power consumption and waste heat are reduced, and the thermal efficiency is improved.

[Application Example of Embodiment]

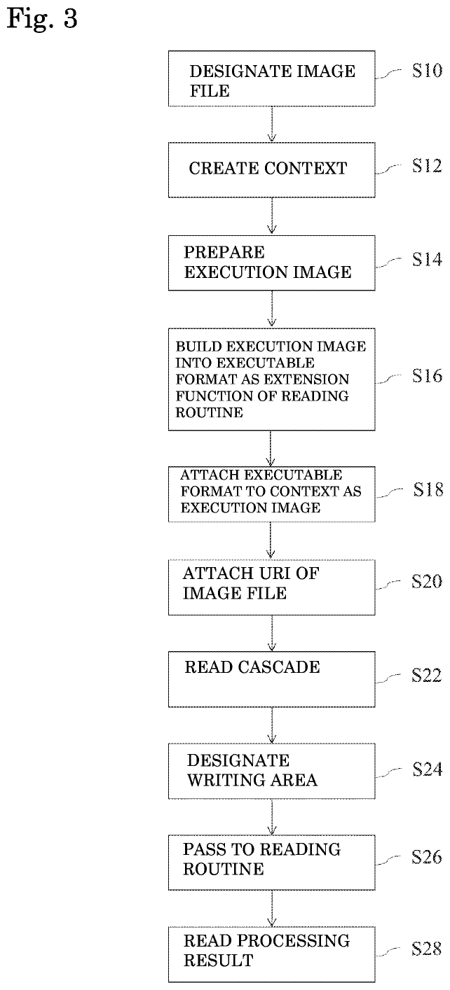

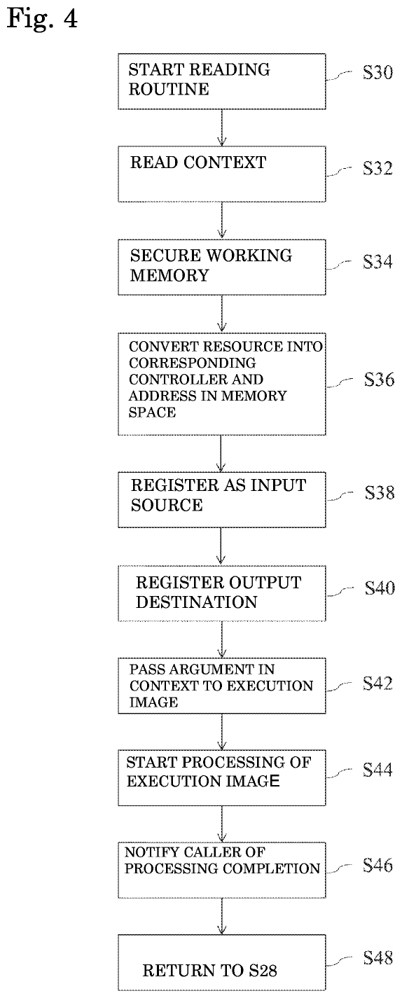

FIGS. 3 and 4 illustrate an example of a flow of processing in an application example of the system according to this embodiment.

As an application example of the system 1 according to this embodiment, an example of a system which executes face recognition of a person included in an image is taken (hereinafter, the system according to the application example is referred to as a “face recognition system”). In the application example, the storage part 20 stores image data including a URI in which a predetermined scheme is associated with a resource in a format defined for each scheme after a predetermined delimiter. Further, the application is an image processing application which performs predetermined processing on image data. Incidentally, in this embodiment, the image data may be image data of a still image and/or image data of a moving image constituent image included in a moving image. The moving image constituent image included in the moving image may be any of a frame image, a field image, and other images of various formats forming a moving image.

Incidentally, the face recognition system is described as an application example of this embodiment. However, the application example is not limited to the face recognition system and can be applied to various fields and applications as long as a system processes various data.

The face recognition system according to the application example is a system for pointing out one or more human face areas included in an image. First, in the face recognition system, in a case where an image file to be processed is designated (step 10, hereinafter, a step is referred to as “S”), the context (that is, various types of control information required for execution of applications) of predetermined processing is created (S12). Herein, the image file is associated with the URI in advance, and the face recognition system refers to the URI of the designated image file and specifies the application designated by the URI as an application to call. Incidentally, in the following description, the “application” and the “reading routine” are the same program.

Next, the face recognition system prepares an execution image (S14). That is, first, the face recognition system causes the specified application to secure a working memory from any of the storage parts of the storage part 20 (for example, the working memory is calculated by the compiler).

Then, the application executes gray scale processing and histogram uniformization processing of the designated image file and reads the file into the working memory. Next, the application executes the face detection processing of the person in the image file, specifies the position of the face (face position), determines the temporary output destination from any of the storage parts 20, and draws circles at all face positions detected in the temporary output destination. In this way, the face recognition system prepares the execution image.

Next, the face recognition system builds the prepared execution image into an executable format as an extension function of the “reading routine” (S16). Then, the face recognition system attaches the built executable format as an execution image to the context created in S12 (S18). Further, the face recognition system attaches the URI of the image file to be processed as an argument of the context (S20), and reads “cascade of classifiers” as the argument of the context (S22). Incidentally, the cascade of classifiers is a discriminator in which a plurality of strong discriminators is connected, and each strong discriminator executes discrimination processing in a permutation.

The face recognition system designates an “area for writing a processing result” as an argument in the context (S24). Then, the face recognition system calls the “reading routine” and passes the context to the “reading routine” to execute the face recognition processing (S26).

In a case where the application which is the “reading routine” receives the context from the face recognition system, the application starts the reading routine (S30) and reads the context (S32). Then, the application secures the working memory from any of the storage parts 20 (S34). The application converts the resource passed in the URI of the argument of the context into the corresponding controller and the address in the memory space connected to the controller (536). That is, the application converts the URI into the data position.

The application registers the controller and the address of the memory space as an “input source” (538), specifies the “area for writing the processing result”, and registers the specified area as an “output destination” (S40). Next, the application passes the argument in the context to the execution image (S42) and starts the processing of the execution image (S44). In the processing of the execution image, the image data acquired from the “input source” is subjected to gray scale processing and histogram uniformization processing and read into the “working memory”, and the face detection processing is executed. Then, the application draws a circle at the face position at the “output destination”. Accordingly, the processing of the execution image is completed.

In a case where the application completes the processing of the execution image, the application notifies the caller of the completion of the processing of the execution image (S46), and the face recognition system reads the processing result from the context (S28). Accordingly, the position of the human face is pointed out in the image. Incidentally, in a case where the reading (S28) of the processing result by the face recognition system is completed, the application releases the context including the execution image and the working memory.

In the face recognition system according to the application example, the processing of transferring the image file data is not executed, and thus, it is not necessary to secure the reading memory. Further, in the face recognition system, the application for reading is designated by the URI indicating the reading destination, and thus, the same image file can be controlled by the same URI even in a case where the image file exists in any of the memory space on the DRAM 204, the file on the SSD 208, the video memory 206, or the like. Further, in the face recognition system, the execution image can be designated as an extension function attached to the “reading routine”, and thus, the face recognition can be executed in the process of reading the image file,

In the above description, each part of the system 1 or the face recognition system may be realized by hardware or may be realized software. Further, the part may be realized by a combination of hardware and software. The program may be installed in the computer configuring the system 1 or the face recognition system from a computer-readable medium or a storage device connected to a network.

The program installed in the computer and causing the computer to function as the system 1 or the face recognition system according to this embodiment operates the CPU or the like to cause the computer to function as the system 1 or the face recognition system. The information processing described in the program is read by the computer to function as a specific means in which the software and the hardware resource of at least one of the system 1 and the face recognition system cooperate. Then, when the processing of information according to the purpose of use of the computer in this embodiment is executed by such a specific means, it is possible to configure the system 1 or the face recognition system unique according to the purpose of use.

Further, in an information processing device which includes a data unit having a CPU, a ROM, a RAM, a communication interface and the like, an input unit such as a keyboard, a touch panel and a microphone, an output unit such as a display and a speaker, and a storage unit such as a memory and an HDD, the system 1 or the face recognition system may be realized by activating software or a program that defines the operation of each part of the system 1 or the face recognition system.

The program for the system 1 or the face recognition system can be provided in the system 1 or the face recognition system via a communication network such as the Internet or a recording medium such as a magnetic recording medium or an optical recording medium. Further, the program for the system 1 or the face recognition system stored in the system 1 or the face recognition system is executed by the CPU or the like. The recording medium storing the program may be a non-transitory recording medium such as a CD-ROM or a DVD.

Although the embodiments of the present invention have been described above, the embodiments described above do not limit the invention according to the claims. Further, it should be noted that not all of the combinations of features described in the embodiments are essential to the means for solving the problems of the invention. Further, the technical elements of the above-described embodiments may be applied independently or may be applied by being divided into a plurality of parts such as a program part and a hardware part.

### REFERENCE SIGNS LIST

1 System
2 Memory hierarchy
10 Control part
20 Storage part
200 Register
202 Cache
204 DRAM
206 Video memory
208 SSD
210 HDD
212 Tape drive
300 Data transfer

1. A system comprising: a control part; and a storage part which stores data on a basis of a data position, wherein
the system uses, as a pointer for accessing the data, a uniform resource identifier (URI) in which a predetermined scheme is associated with a resource in a format defined for each scheme after a predetermined delimiter instead of the data position,
the control part controls and activates an application designated by the scheme associated with the URI and passes the resource of the URI to the application, and
the application uses the URI as the data position on a basis of the resource and controls data specified by the URI and stored in the storage part.

2. The system according to claim 1, wherein
the storage part includes a plurality of storage parts to which the data positions of different formats are assigned, and
the application designates data stored in each of the plurality of storage parts on a basis of the URI.

3. The system according to claim 1, wherein the plurality of storage parts include at least two storage parts selected from a group including a register, a cache, a DRAM, a video memory, an SSD, a HDD, a tape drive, an optical recording medium, a magneto-optical storage medium, and a magnetic recording medium.

4. The system according to claim 1, wherein the control part controls and activates a plurality of applications on a basis of the scheme associated with the URI.

5. The system according to claim 1, wherein the data position is a physical address.

6. The system according to claim 1, wherein the data position is specified including at least an IO controller number.

7. The system according to claim 1, wherein
the storage part stores image data including a URI in which a predetermined scheme is associated with a resource in a format defined for each scheme after a predetermined delimiter, and
the application is an image processing application which performs predetermined processing on the image data.

8. A data processing method in a system which includes a control part and a storage part which stores data on a basis of a data position, the method comprising:
a step of using, by the system, as a pointer for accessing the data, a uniform resource identifier (URI) in which a predetermined scheme is associated with a resource in a format defined for each scheme after a predetermined delimiter instead of the data position;
a step of controlling and activating, by the control part, an application designated by the scheme associated with the URI and passing the resource of the URI to the application; and
a step of using, by the application, the URI as the data position on a basis of the resource and controlling data specified by the URI and stored in the storage part.

9. A program for a system which includes a control part and a storage part which stores data on a basis of a data position, the program for causing a computer to realize:
a function of using, as a pointer for accessing the data, a uniform resource identifier (URI) in which a predetermined scheme is associated with a resource in a format defined for each scheme after a predetermined delimiter instead of the data position;
a function of controlling and activating an application designated by the scheme associated with the URI and passing the resource of the URI to the application; and
a function of the application using the URI as the data position on a basis of the resource and controlling data specified by the URI and stored in the storage part.

10. A program for a system which includes a control part and a storage part which stores data on a basis of a data position, the program for causing a computer to realize:
a function of using, as a pointer for accessing the data, a uniform resource identifier (URI) in which a predetermined scheme is associated with a resource in a format defined for each scheme after a predetermined delimiter instead of the data position;
a function of controlling and activating an application designated by the scheme associated with the URI and passing the resource of the URI to the application; and
a function of the application using the URI as the data position on a basis of the resource and processing data specified by the URI and stored in the storage part.
